(19) United States
(12) Patent Application Publication
(10) Pub. No.: US 2025/0390091 A1
(43) Pub. Date: Dec. 25, 2025

(54) DATA QUALITY MANAGEMENT METHOD FOR EQUIPMENT FAILURE RISK ESTIMATION

(71) Applicant: Schlumberger Technology Corporation, Sugar Land, TX (US)

(72) Inventors: Jinlong Kang, Clamart (FR); Ahmed Mosallam, Clamart (FR)

(21) Appl. No.: 18/748,210

(22) Filed: Jun. 20, 2024

(51) Int. Cl. G05B 23/02; E21B 41/00

(52) U.S. Cl. CPC G05B 23/0283; E21B 41/00

(57) ABSTRACT

A method for managing a quality of data that is used to estimate a risk of failure of equipment includes receiving input data representing the equipment. The method also includes determining a loss function for assessing a performance of a risk estimation model for the equipment. The method also includes determining a relationship between the input data and the performance of the risk estimation model. The relationship is determined based upon the loss function. The method also includes training a decision model based upon the relationship to produce a trained decision model. The method also includes making a decision using the trained decision model. The method also includes estimating the risk of failure of the equipment based upon the decision and the input data.

### BACKGROUND

Risk is commonly characterized as the possibility or likelihood of a potential event occurring. In the specific context of equipment failure risk estimation within the realm of engineering asset management, the risk of failure can be defined as the likelihood of a failure in an industrial system that can lead to costly consequences such as downtime, maintenance costs, and even safety hazards. By quantifying the risk of failure associated with industrial equipment, organizations can prioritize maintenance tasks, reduce unplanned downtime, and extend the life of assets. Therefore, accurate equipment failure risk estimation is helpful in making informed asset management decisions.

Model fitting and data quality are two sources that may be used to help predict uncertainty in risk estimation. While much attention has been devoted to model fitting for risk estimation, the role of data quality has often been overshadowed. Therefore, what is needed is an improved system and method that considers data quality while estimating the risk of equipment failure.

### SUMMARY

A method for managing a quality of data that is used to estimate a risk of failure of equipment is disclosed. The method includes receiving input data representing the equipment. The method also includes determining a loss function for assessing a performance of a risk estimation model for the equipment. The method also includes determining a relationship between the input data and the performance of the risk estimation model. The relationship is determined based upon the loss function. The method also includes training a decision model based upon the relationship to produce a trained decision model. The method also includes making a decision using the trained decision model. The method also includes estimating the risk of failure of the equipment based upon the decision and the input data.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving input data representing the equipment. The input data is measured by one or more sensors on the equipment. The equipment includes a downhole tool or a surface tool that is configured to be used at a wellsite. The operations also include determining a loss function for assessing a performance of a risk estimation model for the equipment. The risk estimation model is configured to estimate the risk of failure of the equipment. The operations also include determining a relationship between a quality of the input data and the performance of the risk estimation model. The relationship is determined based upon the loss function. The relationship is also determined based upon data from similar equipment that is similar to the equipment. The relationship is determined by removing or modifying segments of the data from the similar equipment to produce synthetic datasets having different levels of data quality. The operations also include training a decision model based upon the relationship and a decision tree algorithm to produce a trained decision model. The decision model is trained based upon the synthetic datasets. The operations also include making a decision using the trained decision model. The operations also include estimating the risk of failure of the equipment based upon the decision and the input data.

A non-transitory computer-readable medium is also disclosed. The medium stores instructions that, when executed by one or more processors of a computing system, cause the computing system to perform operations. The operations include receiving input data representing the equipment. The input data is measured by one or more sensors on the equipment. The one or more sensors are part of a computerized maintenance management system (CMMS) associated with the equipment. The input data includes electrical current data, electrical voltage data, shock data, vibration data, temperature data, or a combination thereof. The equipment includes a downhole tool or a surface tool that is configured to be used at a wellsite. The operations also include determining a loss function for assessing a performance of a risk estimation model for the equipment. The risk estimation model is configured to estimate the risk of failure of the equipment. The loss function is represented as:

$$ℓ ∝ r \times \frac{{\sum }_{i = 1}^{N} ( {\hat{T}}_{i} \geq {T}_{i} )}{{\underbrace{N}}_{term 1}} + \frac{{\sum }_{i = 1}^{N} ( {T}_{i} - {\hat{T}}_{i} ) ( {\hat{T}}_{i} < {T}_{i} )}{{\underbrace{N}}_{term 2}} .$$

where: [symbol] represents the loss function; N represents a number of equipment; \hat{ }Ti represents a time when one of the equipment i is replaced based upon a failure risk estimation. Each equipment's life starts at time 0, and the equipment i is replaced when the failure risk estimation reaches a predetermined level. The variable Ti represents an actual life of the equipment i based upon a time when the equipment i actually fails. The variable r represents a cost ratio comprising a unit failure cost of the equipment i divided by a premature replacement cost of the component i per unit time. The unit failure cost is a cost caused by an undetected failure of the equipment i. The variable I represents an indicator function. The operations also include determining a relationship between a quality of the input data and the performance of the risk estimation model. The relationship is determined based upon the loss function. The relationship is also determined based upon data from similar equipment that is similar to the equipment. The relationship is determined by removing or modifying segments of the data from the similar equipment to produce synthetic datasets comprising different levels of data quality. The operations also include training a decision model based upon the relationship and a decision tree algorithm to produce a trained decision model. The decision model is trained based upon the synthetic datasets. The operations also include making a decision using the trained decision model. The operations also include estimating the risk of failure of the equipment based upon the decision. The risk of failure is estimated using the selected risk estimation model. The risk of failure is also based upon the input data.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for managing a quality of (e.g., input) data that may be used to estimate the risk of failure of equipment, according to an embodiment.

FIG. 3 illustrates flowchart for data quality requirements decision-making process, according to an embodiment.

FIG. 4 illustrates a new loss function that captures the effects of these cost differences on the loss function, according to an embodiment.

FIG. 5 illustrates a schematic view of a data quality management framework for equipment failure risk estimation, according to an embodiment.

FIG. 6 presents a summary of the elements that provide a more straightforward overview of the primary data stored in a CMMS, according to an embodiment.

FIG. 7 illustrates data preprocessing consists of four steps, namely, data cleaning, feature extraction, feature transformation, and feature reduction, according to an embodiment.

FIG. 8 illustrates a drilling system for oil well construction that includes a drilling rig, a drill pipe, and a bottomhole assembly (BHA), according to an embodiment.

FIG. 9 illustrates a logging-while-drilling tool in the BHA, according to an embodiment.

FIG. 10 illustrates a rotary steerable system (RSS) in the BHA, according to an embodiment.

FIG. 11 illustrates an algorithm (e.g., Algorithm 1), according to an embodiment.

FIG. 12 illustrates an excerpt of the acquired knowledge K (Q,Ω, r, [symbol] ), according to an embodiment.

FIG. 13 illustrates an optimal model under different data volumes, completeness, and cost ratios, according to an embodiment.

FIG. 14 illustrates a decision model for determining the best model without minimal performance, according to an embodiment.

FIGS. 15-19 illustrate decision models, according to an embodiment.

FIG. 20 illustrates results of the confusion metrics under different, according to an embodiment.

FIG. 21 illustrates a decision derivation process (e.g., for both scenarios), according to an embodiment.

FIG. 22 illustrates the model's performance before and after the data quality improvement, achieved by including two additional failed boards and addressing missing values, according to an embodiment.

FIG. 23 illustrates a flowchart of a method for managing a quality of data that is used to estimate a risk of failure of equipment, according to an embodiment.

FIG. 24 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if”' may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

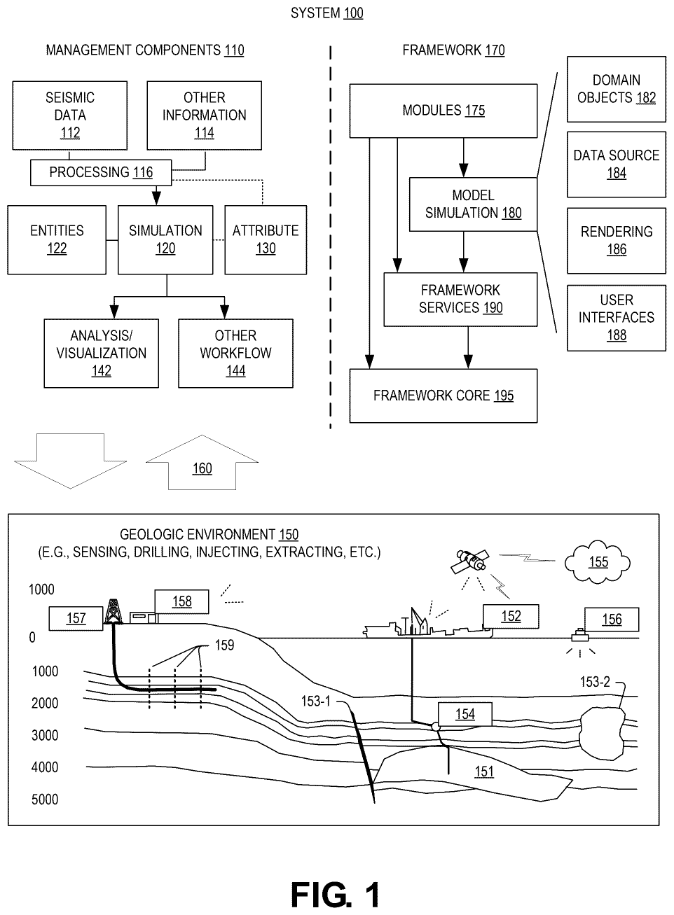

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the. NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Data Quality Management Method for Equipment Failure Risk Estimation

The present disclosure presents a method for managing data quality for estimating the risk of failure of industrial equipment. The method includes the following phases: data development, data quality assessment, data quality standard decision-making, data quality improvement, and/or risk estimation model development. The method furnishes valuable guidance for data practitioners seeking to manage the data quality that is used for risk estimation. The method also provides detailed guidelines that can help the data practitioners build individualized data quality standard decision-making models for estimating the risk of failure of their equipment. The decision-making model can measure the adequacy of existing data and/or build a risk estimation model that meets the specified criteria. The decision-making model can also determine/select the (e.g., best) risk estimation model from a plurality of models given the available data.

The method may incorporate a decision tree-based model for evaluating the compliance of the data quality (e.g., to determine whether the data meets the data quality requirements) and the best risk estimation model. As used herein, the “data quality” or “quality of the data” refers to how well the data meets the requirements of failure risk estimation. The decision tree-based model may also or instead select a (e.g., best) risk estimation model from a plurality of models. Additionally, the method introduces an improved loss function featuring a “cost ratio” parameter, enabling the model to accommodate equipment with varying failure costs versus early replacement costs. In addition, the method may introduce an indicator to measure the effect of the data quality on performance of the model that estimates the risk of failure of the equipment. The method may include a data quality standard decision-making process to determine whether the data quality meets the desired criteria and/or the (e.g., best) risk estimation model.

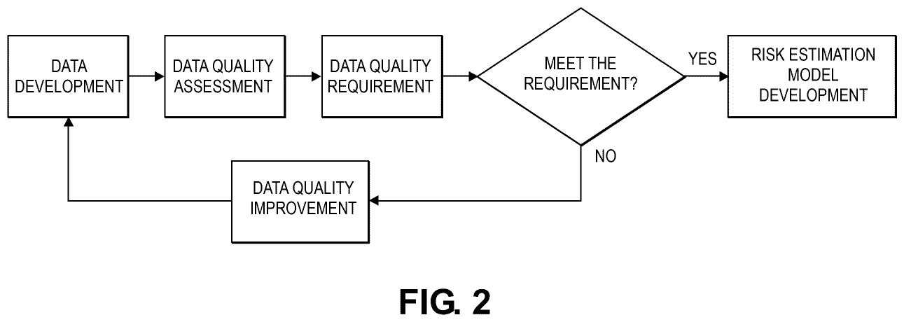

FIG. 2 illustrates a flowchart of a method for managing a quality of (e.g., input) data that may be used to estimate the risk of failure of equipment, according to an embodiment. As mentioned above, the method may include five phases: data development, data quality assessment, data quality standard, data quality improvement, and risk estimation model development.

The method may include a new decision-making process for determining whether the data quality meets specific criteria. The method may be based on the relationship between model performance and data quality. The method may generate, update, and/or use a decision tree model. In addition, the model performance may be evaluated based on the average maintenance cost for the equipment. Thus, this method for determining data quality standard takes costs into account.

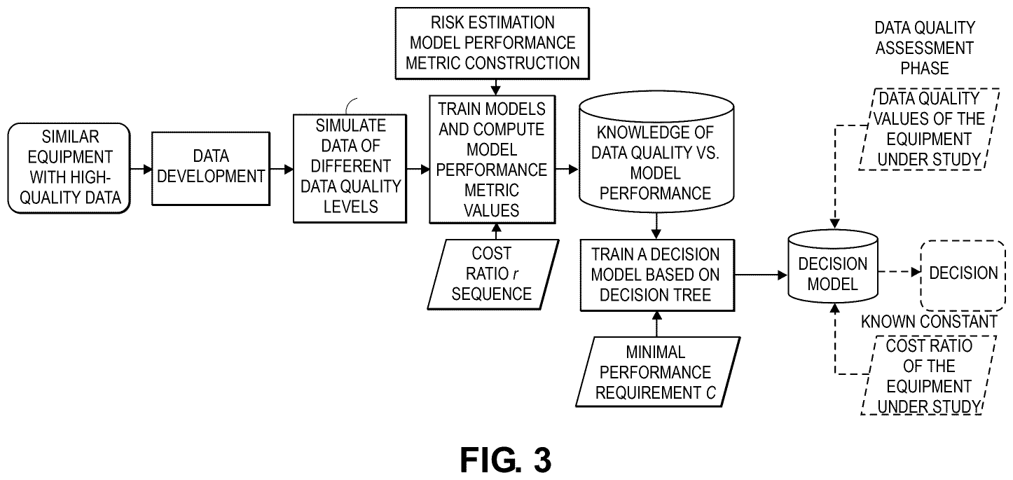

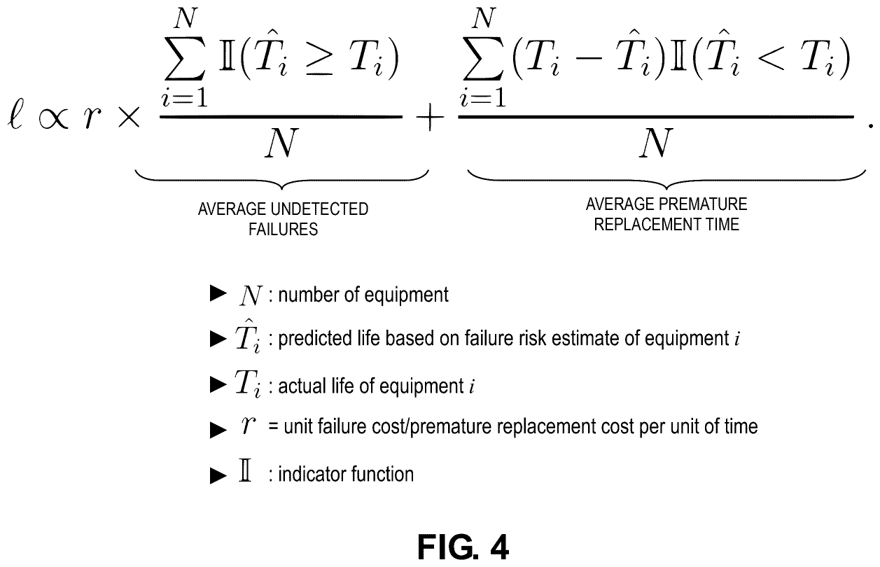

FIG. 3 illustrates flowchart for data quality requirements decision-making process, according to an embodiment. Different equipment may have different unit failure costs and premature replacement costs per unit of time. FIG. 4 illustrates a new loss function that captures the effects of these cost differences on the loss function, according to an embodiment. More particularly, the loss function describes performance metrics for a model that estimates the risk of equipment failure.

### Proposed Data Quality Management Framework

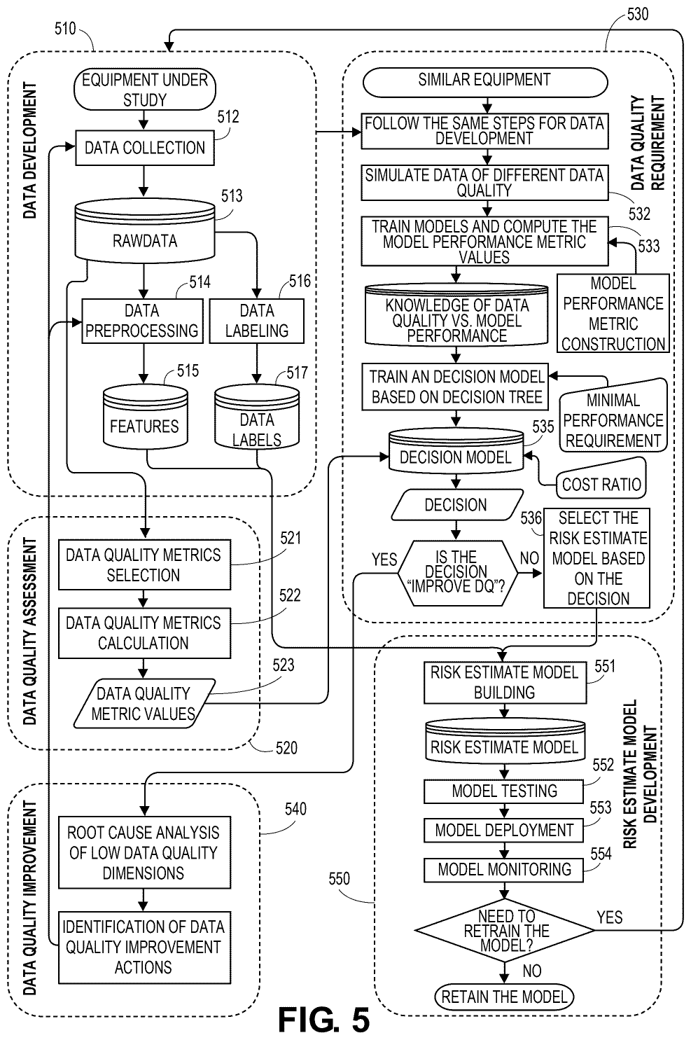

FIG. 5 illustrates a schematic view of a data quality management framework for equipment failure risk estimation, according to an embodiment. As mentioned above, the comprehensive framework may include five phases: data development 510, data quality assessment 520, data quality requirement 530, data quality improvement 540, and risk estimation model development 550. Each of these phases is explained in detail in the following subsections.

### Assumptions

There are several assumptions that may be taken into account before implementing the framework. These assumptions are detailed below:
Equipment Characteristics:
   Failed equipment is considered non-repairable; it can only be replaced with a new unit.
   The studied equipment and the similar equipment share comparable characteristics and have similar sensor data collected.
Data Characteristics:
   The start and end times of life are known for failed equipment; actual risks of failure over time or health states over time are unknown.
   The studied equipment is assumed to be newly implemented or infrequently used, resulting in limited availability of high-quality data.
   The data quality of the studied equipment is assumed not to exceed the data quality of the similar equipment.
   The data quality of the similar equipment is assumed high.
      Unit failure cost and premature replacement cost per unit time are known and considered constants for the specific equipment.

### Data Development 510

Building data-driven models for estimating equipment failure risk may depend upon the data, because the efficacy and usefulness of these models depend heavily on the data quality. This section on data development outlines the four steps used to formulate and process the data, that is, data collection 512, data preprocessing 514, feature extraction 515, and data labeling 516.

### Data Collection 512

Data collection 512 is the first step in data-driven equipment failure risk estimation. This data may be from a computerized maintenance management system (CMMS) associated with the equipment. A CMMS embodies software infrastructure tailored to centralize maintenance intelligence and streamline the orchestration of maintenance activities. It is designed to optimize the utilization and availability of physical equipment such as machinery, vehicles, transportation infrastructure, plant facilities, and associated resources. A spectrum of information may be stored within the CMMS database, encompassing details about equipment identity, operation data, work orders, materials inventory, and more. Equipment operation data includes readings taken from various sensors mounted on the equipment. Some of these sensors may be attuned to multiple aspects of the operating environment, including temperature sensors employed to gauge equipment temperature and accelerometers used to quantify equipment vibration. Additionally, specific sensors, such as transmitters and receivers, may be integral to the equipment's function. The scope of work orders includes various categories, including maintenance, equipment order, shipment, and related operational tasks.

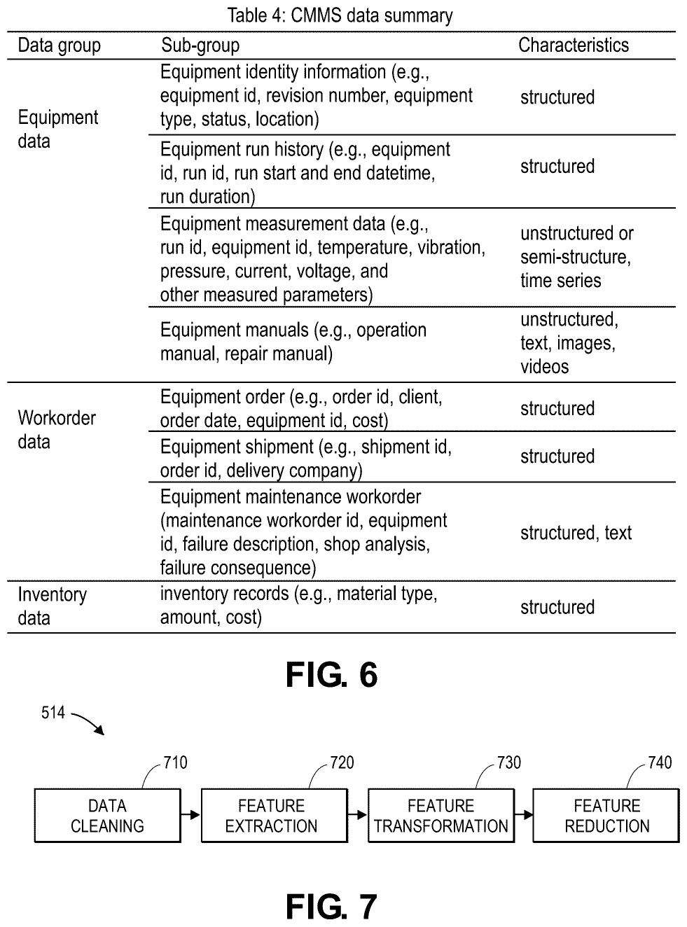

FIG. 6 presents a summary of the elements that provide a more straightforward overview of the primary data stored in a CMMS, according to an embodiment. As evident from the preceding description, the CMMS database may be abundantly stocked with a profusion of data. However, utilizing this data to estimate the risk of equipment failure may be difficult. Specific subsets of data from the CMMS database may be selectively extracted. For equipment failure risk estimation, equipment identity information, equipment run history, operating environment data (e.g., temperature, vibration) in equipment measurement data, and associated maintenance work orders may be collected. This careful selection of data elements emphasizes a pragmatic approach to identifying the data needed for accurate equipment risk assessment.

### Data Preprocessing 514

Data preprocessing 514 is a process of refining and reshaping raw data 513 into a format suitable for subsequent risk estimation model training. Conventionally, this process involves engineering effort and is characterized by iterative improvement through rigorous trial and error handling. FIG. 7 illustrates data preprocessing 514 includes four steps, namely, data cleaning 710, feature extraction 720, feature transformation 730, and feature reduction 740, according to an embodiment. Each of these plays a different role.

Data cleaning 710 involves carefully identifying and correcting errors and inconsistencies in the dataset, such as missing values, outliers, and duplicates. Industrial equipment operational data cleansing may include additional steps beyond regular data cleansing. These extra steps may rely on the knowledge of Subject Matter Experts (SMEs), who have developed superior expertise and experience in the equipment. SMEs may belong to diverse fields, including reliability, electrical, and physics engineering, and bring a wealth of specialized knowledge to bear on the task. For example, it is often recommended that operational data during equipment startup and shutdown be deleted, because data recorded during these periods may include too much noise due to unstable operation. Therefore, it may be helpful to rely on SME knowledge to determine the stable operation phase of the equipment. Additionally, leveraging unsupervised methods can aid SMEs in effectively exploring data within a specific domain.

Feature extraction 720 aims to extract discriminative features 515 from the raw data 503 that can be consumed by failure risk estimate models 536. Many studies have been conducted on general-purpose equipment such as gearboxes and motors. Common statistical features 515 can be extracted for these types of equipment based on existing methods such as time-domain, frequency domain, and time-frequency-domain analysis methods. However, for unique, specialized equipment, such as drilling and measuring tools in the oil and gas industry, the feature extraction process usually involves SMEs to guide the feature extraction. These methods can automatically learn features 515 through deep networks. However, the transfer of deep learning to real industrial applications is limited because of its weak interpretability and computational complexity. In many real-world industrial artificial intelligence applications, conventional feature extraction techniques are still favored to ensure interpretability of results and reduce sensitive information.

Feature transformation 730 involves transforming original features 515 into new representations to improve model performance. Commonly used feature transformation methods include normalization and standardization. Normalization scales the data to a common range like [0,1] or [−1,1], while standardization converts the data to zero mean and unit variance. Both methods aim to promote uniformity of data magnitude across attributes, ensure that the features 515 contribute equally to the model, and avoid the dominance of features 515 with larger values. Other techniques include Box-Cox transformation for transforming skewed data and generating new features 515 by multiplication between features 515.

Feature reduction 740 includes two approaches: feature selection and dimensionality reduction. Feature selection is a process that entails the choice of a subset of input features 515 from a dataset. Feature selection methods can be classified into two categories: unsupervised and supervised.

Unsupervised feature selection: Unsupervised methods do not rely on the target variable (i.e., the failure risk in the context of equipment risk estimate) for selection. Instead, these methods eliminate redundant features 515 based on correlations among features 515. The goal is to retain the most informative features 515 while removing highly correlated ones, which can lead to multicollinearity.

Supervised feature selection: Supervised methods, in contrast, employ target variables in the selection process. These methods can be further categorized into three subtypes:
Wrapper methods: Wrapper methods iteratively search for a subset of features 515 that yield optimal model performance. Examples include backward elimination, where features 515 are removed step by step, and forward selection, which adds features 515 incrementally.
Filtering methods: Filtering methods select a subset of features 515 based on their relationship with the target variable. This relationship is quantified using various metrics like Pearson's correlation coefficient or Spearman's rank correlation, depending on the nature of the variables involved (continuous or categorical). Features 515 are ranked or scored, and a predetermined threshold is applied to select the best subset.
Embedded methods: Embedded methods integrate feature selection into the model training process. Features 515 are automatically chosen during model training based on their importance in predicting the target variable. Examples of embedded feature selection methods include decision trees, lasso regression, and ridge regression.

The choice of which feature selection method to implement depends on the specific problem, the dataset's characteristics, and the goals of the analysis. Each method has advantages and limitations, and selecting the most suitable approach may help to optimize model performance and interpretability. Dimensionality reduction is another aspect of feature reduction that aims to transform high-dimensional features 515 into a low-dimensional space while retaining salient information. One of the most widely used methods of dimensionality reduction is principal component analysis.

### Data Labeling 516

Data labeling 516 is a process in data development. It involves attaching one or more meaningful and informative labels to the raw data 513, usually time series sensor data, in the context of industrial equipment failure risk estimation. These labels may convey information regarding the equipment's health status (or fault mode) and the underlying failure mechanisms, enabling data practitioners (e.g., data scientists) to select correct data for model training. Maintenance work orders can also be initiated in response to suspected equipment failures; notably, maintenance technicians rather than maintenance experts often record the failure description and shop analysis provided in maintenance work order data. As a result, there can be uncertainty regarding the accuracy of the failure reports in the maintenance work order and the identification of the failure root cause.

Furthermore, unlike more common annotation tasks, such as image or text annotation, which can be assigned to individuals with general expertise, labeling data derived from industrial equipment sensor readings is a more complex and costly endeavor. This complexity arises primarily from an in-depth understanding of equipment operations, maintenance protocols, and the underlying mechanisms of failure. Consequently, the responsibility for labeling industrial equipment sensor data may be entrusted to SMEs. SMEs play a role in reviewing the sensor data, along with the failure descriptions and shop analyses contained in the associated maintenance work order data to validate the failure's occurrence and its root cause. To gain a deeper understanding of the failure and its contributing factors, in some instances, failed equipment may return to the technology center to undergo a more extensive investigation process, where a detailed analysis is conducted.

### Data Quality Assessment 520

Data quality assessment 520 is one of the five phases in data quality management. It aims to evaluate the suitability of a dataset for its intended purpose. Quantitative data quality metrics may enable data practitioners to calculate values 523 that offer insights into the data's fitness for use. The process of data quality assessment 520 includes the following two steps.

(1) Data quality metric selection 521: This initial step involves identifying and selecting pertinent data quality metrics. The choice of metrics should align with the specific application context and the data characteristics. There may be five parameters for data quality metrics, namely, the existence of minimum and maximum metric values (R1), the interval scaling of the metric values (R2), the quality of the configuration parameters, and the determination of the metric values (R3), the sound aggregation of the metric values (R4), and the economic efficiency of the metric (R5). These criteria support both decision-making under uncertainty and economically oriented data quality management.

(2) Data quality metric calculation 522: Once the relevant data quality metrics are chosen, the next step is to apply these metrics to the dataset. This step involves calculating the metric values 523 based on the dataset's characteristics and the definitions of the selected metrics. For example, completeness metrics involve calculating the percentage of missing values, while data volume metrics assess the number of samples.

### Data Quality Requirement 530

Once the data quality assessment 520 has been completed, it may be determined whether the data quality meets the data quality targets. A straightforward approach is establishing thresholds for data quality metrics, but determining these thresholds remains challenging. The present disclosure proposes a new method for determining if the data quality meet specific standards. The method is based on the relationship between model performance and data quality, and a decision tree model. In addition, model performance may be evaluated based on the average maintenance cost. Thus, this method for determining data quality targets takes costs into account. An indicator may be used to assess the performance of the equipment risk estimation model and then describe how to acquire knowledge of the relationship.

### Risk Estimation Model Performance Metric

When assessing the risk of equipment failure in an industrial environment, it is often challenging to determine the actual risk of failure over time, which is especially true for complex equipment with particularly complex failure mechanisms. In such cases, available data usually provides information on when equipment failures occurred. On the other hand, cost factors play a pivotal role in maintenance decisions guided by risk estimation. Consider the scenario where a component is the primary driver of equipment failures, and this component cannot be repaired; rather, it may be replaced. In this case, the risk-based maintenance decision-making process involves three principal costs: component replacement cost, cost associated with undetected failures, and cost associated with premature component replacement. The first of these costs is often deterministic, while the latter two depend on the accuracy of the risk assessment model.

Specifically, suppose the risk estimation model can predict the component failures accurately. In that case, the components can be replaced at the (e.g., optimal) time, thus avoiding any losses due to failures or premature replacement. However, if the model predicts the failure too late, it can incur costs associated with equipment failures. Conversely, if the model predicts failures too early, it may lead to component replacement for components that are still functional. Given the above analysis, the authors proposed a loss function for assessing the performance of a risk estimation model in their prior work:

$$ℓ = \frac{{\sum }_{i = 1}^{N} [ {c}_{1} ( {\hat{T}}_{i} \geq {T}_{i} ) + {c}_{2} ( {T}_{i} - {\hat{T}}_{i} ) ( {\hat{T}}_{i} < {T}_{i} ) ]}{N} \qquad ( 1 )$$

where:
N: the number equipment.
\hat{ }Ti: the time when the equipment i is replaced based on failure risk estimation, assuming the equipment's life start at time 0; specifically, the equipment i is replaced when the failure risk estimate reaches a certain level.
Ti: actual life of equipment i, (i.e., the time when the equipment actually failed).
c1: unit failure cost, i.e., the cost caused by one undetected failure.
c2: premature replacement cost per unit of time.
I is an indicator function. In other words, \hat{ }Ti≥Ti means the equipment i is replaced too late, which incurs failure cost, while \hat{ }Ti<Ti means the equipment i is replaced too early, which incurs premature replacement cost.

Different equipment may have different unit failure costs and premature replacement costs per unit of time. To capture the effect of these cost differences on the loss function and reduce the number of cost parameters, this disclosure enhances the loss function by introducing a new parameter called cost ratio (denoted as r=c1/c2). Firstly, Eq. (1) can be written as Eq. (2).

$$ℓ = {c}_{2} [ \frac{{c}_{1}}{{c}_{2}} \times \frac{{\sum }_{i = 1}^{N} ( {\hat{T}}_{i} \geq {T}_{i} )}{N} + \frac{{\sum }_{i = 1}^{N} ( {T}_{i} - {\hat{T}}_{i} ) ( {T}_{i} < {T}_{i} )}{N} ] \qquad ( 2 )$$

Then, since the cost parameters c1 and c2 are constants for the equipment, Eq. (2) can be further reformulated as Eq. (3) by substituting r for c1/c2.

$$ℓ ∝ r \times \frac{{\sum }_{i = 1}^{N} ( {\hat{T}}_{i} \geq {T}_{i} )}{{\underbrace{N}}_{term 1}} + \frac{{\sum }_{i = 1}^{N} ( {T}_{i} - {\hat{T}}_{i} ) ( {\hat{T}}_{i} < {T}_{i} )}{{\underbrace{N}}_{term 2}} \qquad ( 3 )$$

This new expression consisting of two different terms as shown in Eq. (3). The first term can be interpreted as the average undetected failures, while the second term can be interpreted as the average premature replacement time. Both these terms may be influenced by the data quality, while the parameter r is inherent to the equipment itself. The inclusion of r may be useful, as different equipment exhibit distinct values for ratio between unit failure cost and premature replacement cost per unit of time.

Knowledge of Data Quality vs. Model Performance

Failure risk estimation of industrial equipment is inherently contextual. Different types of equipment have different characteristics and monitoring parameters and, therefore, cannot be cross applied. For example, it may be unwise to attempt to use a model trained 533 on gearbox data for electronic boards, because the fundamental nature of these equipment types and their associated data varies widely. Consequently, the knowledge gained through simulation studies 532 on publicly available datasets, which are often not correlated with the equipment under study, cannot reflect the true relationship between the quality of the data from the equipment under study and the performance of the model.

Adding to this challenge is that obtaining large amounts of high-quality data for newly implemented or infrequently used equipment can be daunting. The present disclosure proposes a new approach for indirectly acquiring knowledge about the relationship between data quality and model performance. Based on data from similar equipment, knowledge about the relationship between data quality and model performance can be obtained through simulation studies 532. In the present disclosure, this knowledge is succinctly represented as K (Q,Ω, r, [symbol] ), where Q denotes a vector containing data quality metrics, Ω represents risk estimation models, r is the cost ratio, and € corresponds to the previously defined loss function in Eq. (3).

The simulation studies 532 are based on carefully processing data from similar equipment. By selectively removing or modifying data segments, data with different levels of data quality can be modeled. These synthetic datasets can train risk assessment models 533, thus effectively exploring the relationship between data quality and model performance. Subsequently, using the same test dataset, these trained models 533 may be used to estimate the lifetime of the test boards, which helps to compare the loss function values. For more robust assessments of model performances, it is recommended that cross-validation techniques are used.

### Decision Model 535

Once this knowledge is obtained, along with the minimum performance requirement, it becomes feasible to develop a decision model 535 using the decision tree algorithm. The choice of the decision tree algorithm may be motivated by its simplicity, ease of understanding, and the capacity to visualize the decision model 535. The decision model 535 can be mathematically expressed as in Eq. (4). The developed decision model 535 can then determine whether the data quality of the equipment under study should be improved and, if not, which risk estimation model is the best.

$$D = g ( C , K ( Q , Ω , r , ℓ ) ) , \qquad ( 4 )$$

where C is the minimum performance standard. It can be determined based on the average cost target thanks to the definition of the loss function. D is the decision predicted by the decision model 535.

A detailed case study is presented below to illustrate the practical application of the method to acquire the knowledge K (Q,Ω, r, [symbol] ) and make decision based on the decision model 535.

### Data Quality Improvement

Data quality improvement involves two steps: analyzing the root causes of low data quality dimensions and identifying data quality improvement actions.

Root cause analysis of low data quality dimensions: The first step in the data quality improvement process is to examine the dimensions of low data quality to discover the root causes of low data quality. This step involves a comprehensive understanding of the data generation mechanisms and collection process. The root causes can be grouped into three categories: hardware-related issues, software-related issues, and human factors. Hardware problems may include insufficient sensor accuracy, capacity limitations and physical damage of memory storage boards, and communication errors during data transfer from lower to upper computer systems. These problems may be rooted in the design and infrastructure of the hardware system. Software issues include data loss or inconsistency due to CMMS system migration or limitations. In addition, data loss issues may occur during the data collection 512; which often stems from human error (e.g., inadvertent data overwriting and field engineers neglecting to upload data to the server).

Identification of data quality improvement actions: After thoroughly analyzing the root causes of data quality deficiencies, the next step is to develop corresponding data quality improvement measures. Improvement measures may include a variety of strategies and initiatives, each aligned with the specific causes and dimensions of data quality that need to be improved. Based on the above analysis of the root causes of low data quality, the data quality of industrial equipment can be improved in the following three area.

System upgrades: This area focuses on improving data quality from a hardware and software technology perspective. For example, deploying enhanced sensors with higher accuracy and upgrading communication systems can reduce measurement errors and inaccuracies, directly affecting data quality. Choosing a powerful, stable, and mature CMMS can also help manage equipment data, avoiding data loss or inconsistency caused by frequent CMMS migrations.

Management improvement: Management improvement centers on modifying (e.g., optimizing) data quality from a management and human factors perspective. Many data quality issues often stem from human error or negligence. As analyzed above, data loss can be due to field technicians forgetting to transfer data from the memory board to the hard drive and upload it to the data cloud. To minimize such issues, increased training and introduction of Key Performance Indicators (KPIs), such as data collection ratios, for field engineers can increase their awareness of the importance and responsibility of data collection. Both technical and management improvements involve an investment of time and resources. In addition, they involve sustained commitment and ongoing efforts to significantly improve data quality. They may be useful for continuous data quality improvement but may not produce immediate results and/or business value.

Data preprocessing improvements: In contrast, data preprocessing improvements offer an immediate and practical approach to improving data quality. One can quickly resolve some data quality issues by employing data preprocessing techniques such as deduplication, outlier detection, and missing value imputation.

Data deduplication aims to compress data through removing duplicated data items and replacing them with a pointer to the unique remaining copy. Intrinsically, it reduces the amount of data and affects the data quality of data volume.

Outlier detection focuses on finding observations that are different from most data. Outlier detection methods can be categorized into four groups: statistical-based, distance-based, density-based, and clustering-based methods. Statistical-based methods rely on statistical techniques to identify outliers. Distance-based methods assess the dissimilarity or distance between data points to determine outliers. Density-based methods focus on the density distribution of data points. They identify outliers as data points existing in regions of low data density. Clustering-based methods seek to partition data into clusters, with outliers being data points that do not conform to any cluster or belong to small, isolated clusters.

Missing value imputation attempts to replace missing data with estimated values. Missing value estimation methods can be categorized into two types: statistical-based and machine learning-based methods. Statistical-based methods rely on statistical measures and patterns within the data to impute missing values. Widely used statistical-based techniques include expectation maximization, linear regression, and imputation using the mean or mode of the available data. Machine learning leverages algorithms and models to predict and impute missing values. Some machine learning-based techniques for missing value imputation include regression trees, random forests, support vector regression, and k-nearest neighbor.

### Risk Estimation Model Development 550

Once it has been determined that the data quality meets the minimum targets, developing a risk assessment model 550 can begin. This stage involves well-defined steps, including model building 551, testing 552, deployment 553, and monitoring 554. These steps in the model development process are described in detail below.

Model building 551: The foundation of risk assessment lies in building the model. In this initial phase, data scientists use the features 515 and data labels 517 from the data development phase to create a robust, accurate model that effectively captures the relationship between input data and risk estimates. The risk estimation model can be formulated as in Eq. (5).

$$Risk = Ω ( X , y ) \qquad ( 5 )$$

where X are the extracted features 515 from the data development phase, and y are the data labels. The data labels 517 here are not the equipment's failure risk, because the actual risk is often difficult to access, as described earlier. The data label 517 here is more of a failure mode or failure mechanism analysis for each device, which helps data scientists select the right data.

Model testing 552: Rigorous testing may be used to assess the performance and reliability of the model. In this phase, the model built above is delivered for field testing to a small group of users who apply the model to new unseen data. Testing helps to identify any issues, such as over- or under-fitting, and ensures that the model generalizes well to the new data.

Model deployment 553: Once the model has performed satisfactorily during testing, the machine-learning engineer or software engineer can deploy it into a production environment, including integrating the model into a system or application for real-time or batch processing of risk estimates. Factors to consider when deploying include scalability, reliability, and ensuring the model is synchronized with the latest data. It may be helpful to monitor the performance of the model in the production environment to identify and address performance drift over time.

Model monitoring 554: Model monitoring is a continuous process to ensure that models continue to perform accurately and reliably in the production environment, including tracking KPIs, detecting deviations from expected behavior, and initiating corrective action where necessary. Monitoring may also include periodically retraining the model with new data to adapt to changing patterns and maintain its predictive accuracy. In addition, monitoring the model can help identify and mitigate potential biases that may arise.

In summary, developing a risk estimation model is a comprehensive process involving multiple players, starting with sufficiently good-quality data and then building, testing, deploying, and monitoring the model. Each of these steps may help to ensure that the model performs well in the initial stages and maintains its validity and fairness in real-world applications.

### Case Study

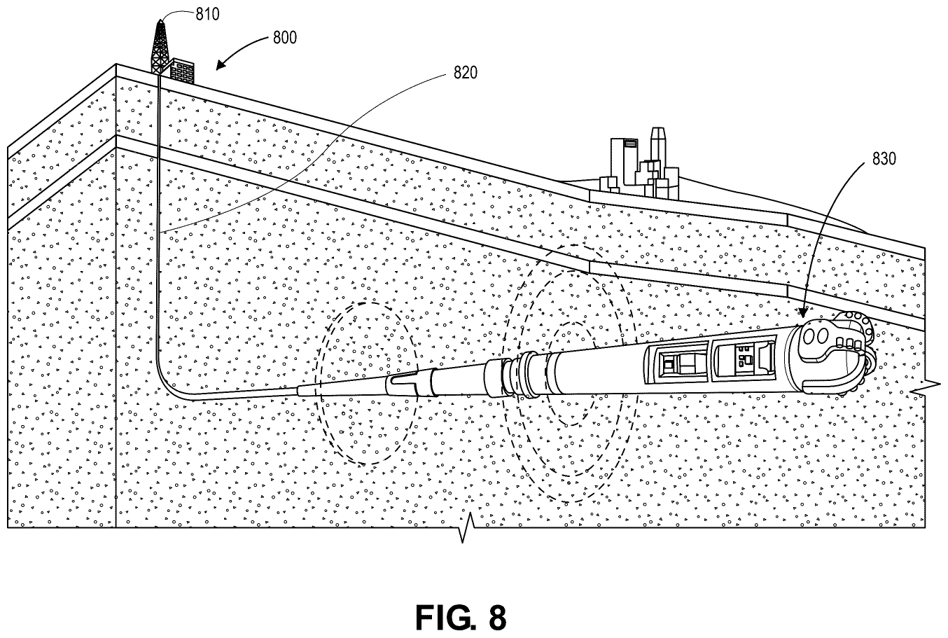

FIG. 8 illustrates a drilling system 800 for oil well construction that includes a drilling rig 810, a drill pipe 820, and a bottomhole assembly (BHA) 830, according to an embodiment. The bottomhole assembly is a part of the drilling system. Oftentimes, the BHA 830 includes a drill bit, a rotary steering system tool, a measurement-while-drilling tool, a logging-while-drilling tool, and other mechanical equipment such as drill collars and stabilizers.

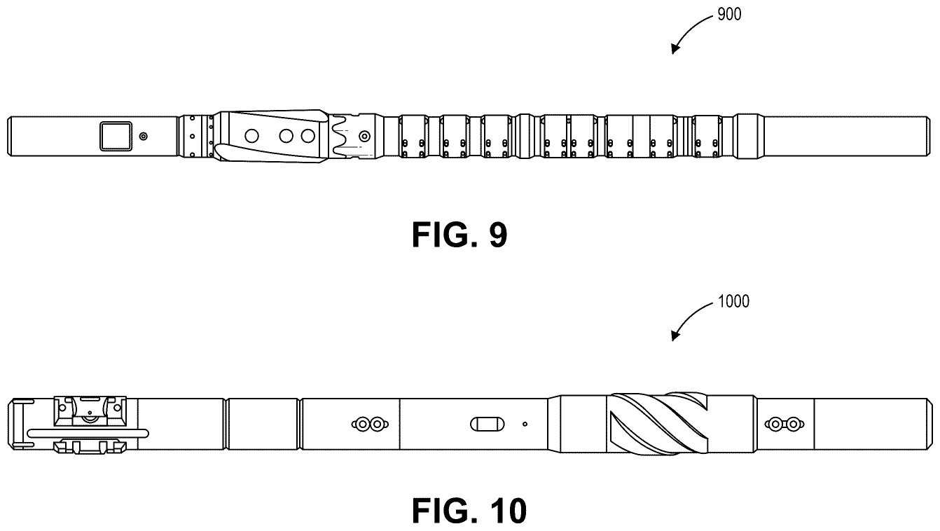

The drilling tools in the bottomhole assembly contain many electronic boards to enable them to perform functions such as data acquisition, signal processing, operation control, and data storage. FIG. 9 illustrates a logging-while-drilling tool 900 in the BHA 830, according to an embodiment. FIG. 10 illustrates a rotary steerable system (RSS) 1000 in the BHA 830, according to an embodiment. The LWD tool and the RSS both include CPUs that achieve similar functions and have the same measured parameters to characterize the operational environment: temperature, shock, and vibration.

### Data Development

The raw data 513 used in this case study was collected during drilling operations in multiple fields worldwide. These drilling operations varied in terms of duration and operating environment. Specifically, operating environment data of 554 failed CPU boards of the rotary steerable system (similar equipment) was collected. The lifetimes of these boards span a range from 500 to 3000 hours. For the CPU board of the logging-while-drilling tool (equipment under study), data was gathered from 18 failed boards. These boards had lifetimes ranging from 700 to 3700 hours. Among these, 12 boards were utilized as training data, while the remaining six boards, which had nearly complete data, were designated for use as test data. The boards mentioned have been confirmed as failed by SMEs, and their raw data 513 was stored in the CMMS.

### Data Quality Assessment

As mentioned earlier, the selection of data quality metrics should align with the specific application context and the characteristics of the data. In this case study, the equipment failure risk estimation is conducted offline, meaning it occurs after the tool has been pulled up from the oil well and is not during drilling operations. Therefore, metrics related to timeliness and currency are not as relevant. Additionally, the sensors in the tool are assumed to be robust, and the readings are considered accurate. As a result, the accuracy of the raw data 513 is not evaluated. Instead, the operational environment data of the drilling tool may have missing values.

Moreover, the data volume may be considered relevant for data-driven models. Hence, in this case study, the selected data quality metrics are completeness (denoted as Comp) and data volume (denoted as n). Data volume is the number of failed CPU boards, while completeness is the life cycle data coverage of the board.

Based on these two metrics, the data quality of the training data for the equipment under study is calculated to be Q=[12, 0.76]. Similarly, the data quality of the test data for the equipment under study is calculated to be Q=[6, 1], where Q=[n, Comp].

### Acquire the Knowledge

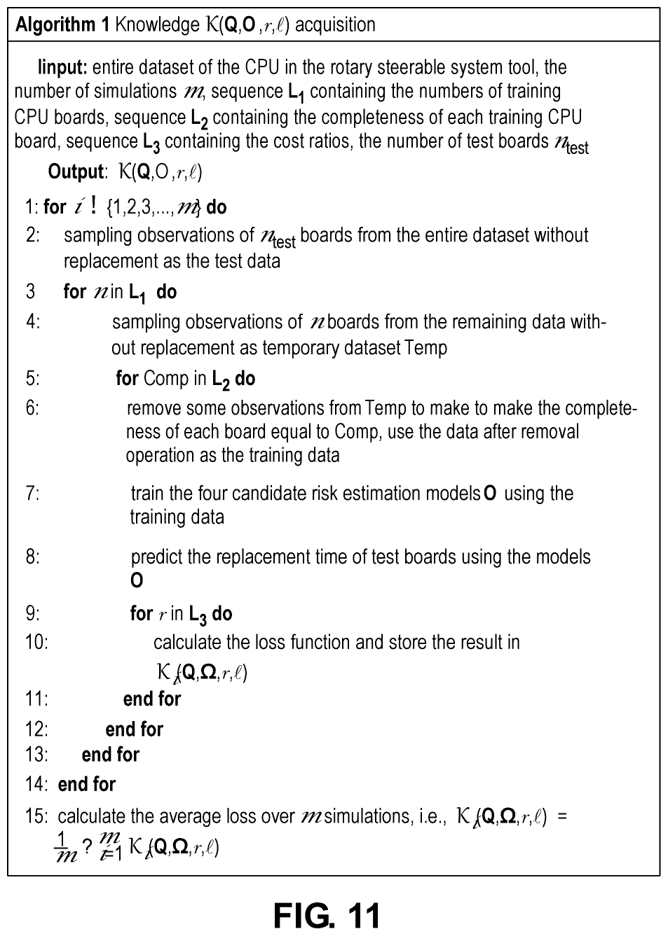

FIG. 11 illustrates an algorithm (e.g., Algorithm 1), according to an embodiment. The procedures for acquiring the knowledge K (Q,Ω, r, [symbol] ) are shown in Algorithm 1. In this case study:
the number of simulations m=60,
the data volume sequence L1 = [2, 3, 4, . . . , 30],
the completeness sequence L2 = [0.50, 0.55, 0.60, . . . , 1.00],
the cost ratio sequence L3 =[50, 100, 200, 400, 500, 1000, 1500, 2000, 3000, 4000, 5000, 6000],
the number of test boards ntest=50.

Four models are compared in this case study, namely, mean time to failure (MTTF), median time to failure (MeTTF), quantile regression (QR), and hidden Markov model (HMM). When the loss function values for MTTF are calculated, the test CPU board is replaced when it reaches the mean time to failure of training boards/data. For MeTTF, the test CPU board is replaced when it reaches the median time to failure of training boards. For QR, the test CPU board is replaced when the predicted remaining lifetime is less than 200 hours. For HMM, the test CPU board is replaced when the estimated risk level reaches the highest risk level.

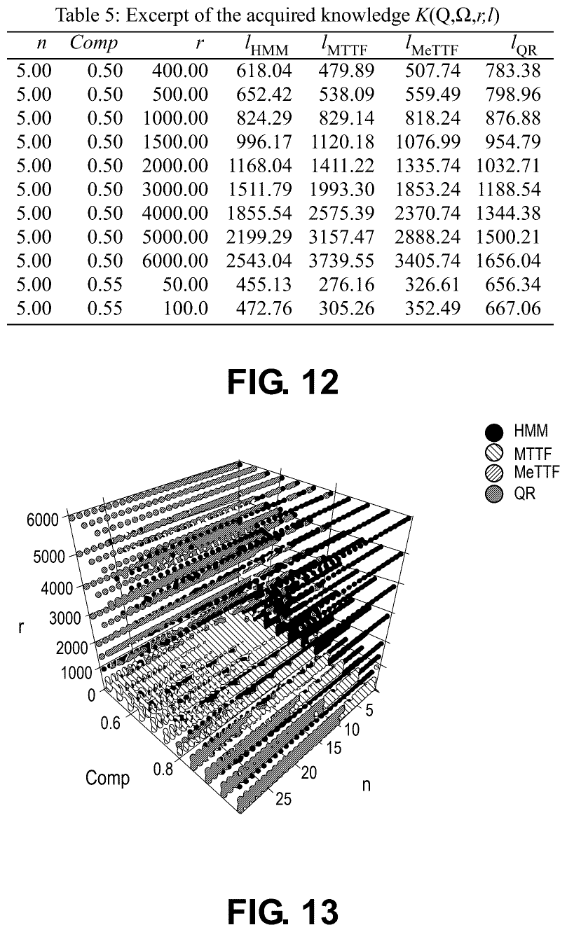

FIG. 12 illustrates an excerpt of the acquired knowledge K(Q,Ω, r, [symbol] ), according to an embodiment. One can also store the average undetected failure (i.e., first term in Eq. 3), and premature replacement time (i.e., second term in Eq. 3) to preserve the knowledge and then calculate the loss using Eq. 3. This way, one can save storage space.

### Build the Decision Model

Based on the acquired knowledge, one can decide which model is optimal by comparing the loss function values if the data volume, completeness, and cost ratio are known. For example, based on the acquired knowledge shown in the first row of FIG. 12, it can be inferred that the best model is MTTF when the data volume, the completeness, and the cost ratio are 5, 0.5, and 400, respectively, because MTTF obtains the minimal loss function value among the four models.

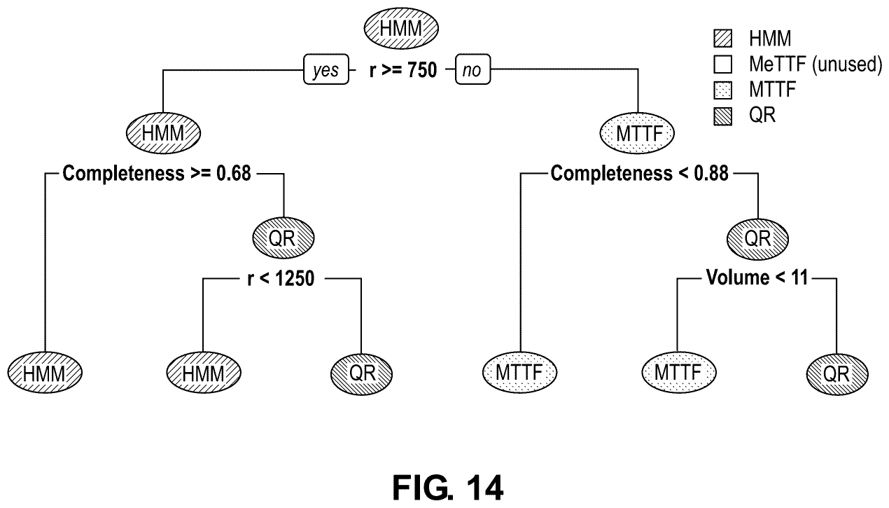

FIG. 13 illustrates an optimal model under different data volumes, completeness, and cost ratios, according to an embodiment. The figure indicates that the QR model tends to perform at a high level when the data volume or the cost ratio is high, the HMM model excels when the completeness is high, and MTTF is favored when the completeness and the cost ratio are low. MeTTF emerges as the top choice in very few scenarios. To enhance precision in model selection, a decision tree is constructed on top of the information presented in FIG. 13. FIG. 14 illustrates a decision model for determining the best model without minimal performance, according to an embodiment. In this figure, the term “unused” in the legend denotes that the class exists in the training data for training the decision tree model. However, its amount is so minimal that it exerts negligible influence on estimating decision tree model parameters.

The node on the split indicates that the corresponding class is the dominant one at that specific split point in the decision tree. In other words, it signifies that the majority of data points at that split belong to that particular class. The decision process follows the left branch if the condition on the node is true, and the right branch otherwise. The node on the leaf (i.e., the most bottom) represents the final decision in the decision tree model. These meanings also apply to the subsequent visualizations of decision trees.

Furthermore, if the minimum model performance standard is also given (e.g., a target that the loss must be not greater than C), then the data quality must be improved if the [symbol] *>C( [symbol] * is the loss function value of the best model). Otherwise, the optimal best model can be determined.

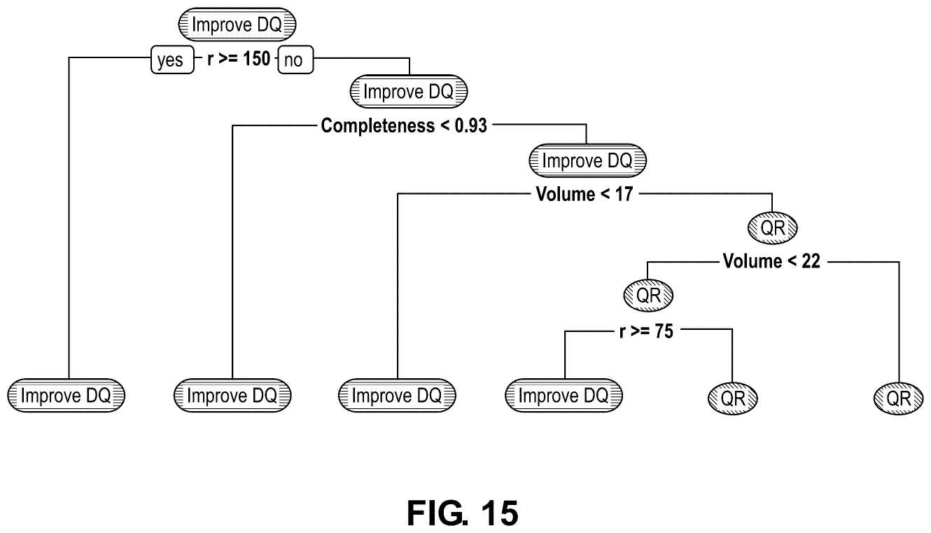

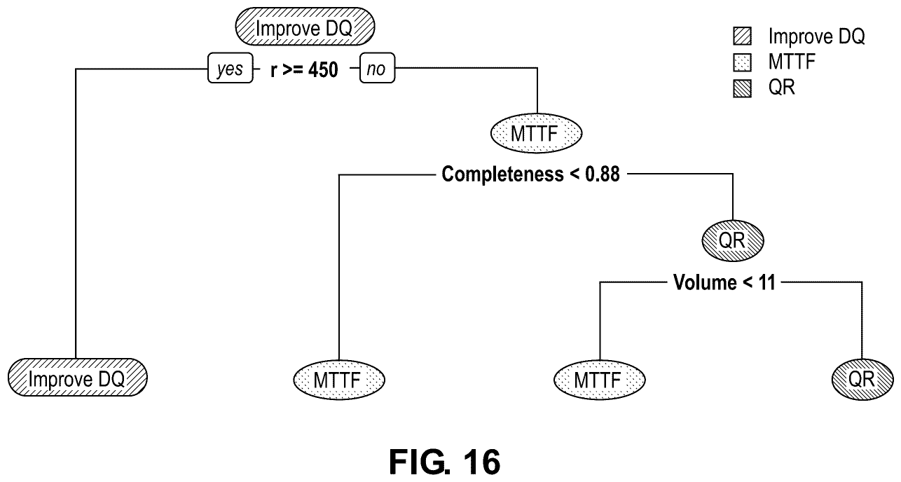

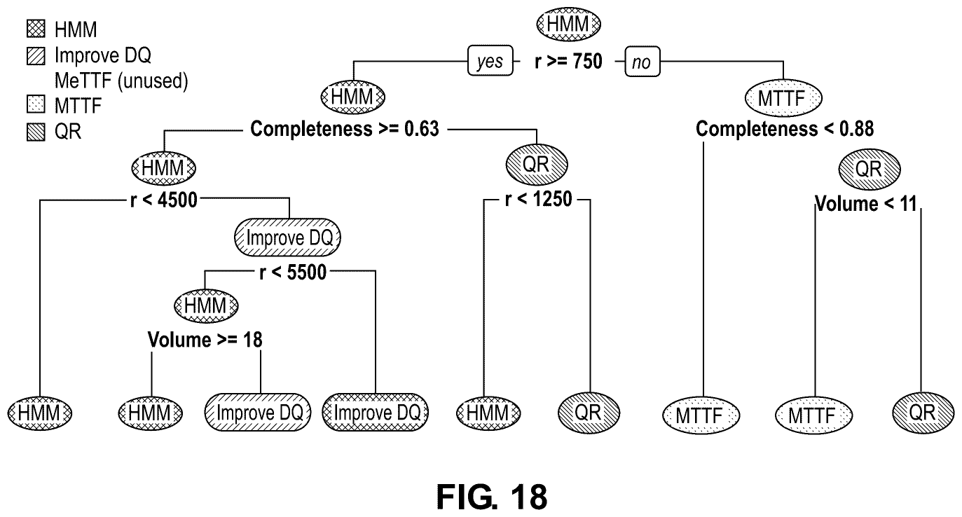

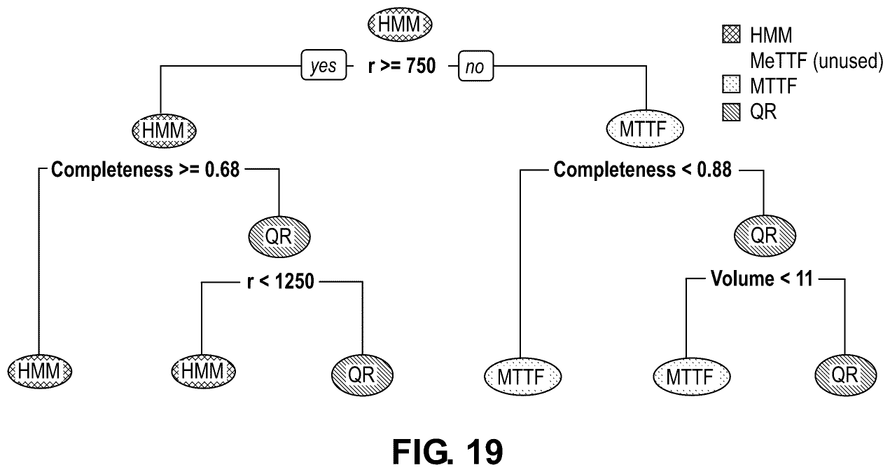

For instance, if the minimum model performance standard C is set at 500, then referring to the information in the initial row of FIG. 12, it can be deduced that MTTF is the optimal model when the data volume, the completeness, and the cost ratio are 5, 0.5, and 400, respectively. This is because MTTF achieves the minimum loss function value among the four models, and its loss is below 500. However, in cases where the data volume, the completeness, and the cost ratio are 5, 0.5, and 500, respectively, as indicated in the second row of FIG. 12, then the decision is to improve the data quality. This is because MTTF obtains the minimum loss function value among the four models, but its loss exceeds the specified threshold C of 500. The decision models for several values of C are illustrated in FIGS. 15-19. In these figures, “Improve DQ” means “Need to improve data quality”. Additionally, it is observed that for small values of C, the prevailing decision tends to be “Improve DQ.” Conversely, when C is larger, the decision model tends to align with the decision model that does not impose a minimum performance standard. This observation is logical because, with small C values, the four models may fall short of meeting the minimum performance standard. In contrast, with large C values, at least one of the four models satisfies the minimum performance standard.

To help make the decision and act to facilitate a comparison of model performance before and after data quality improvement, 10 boards are utilized as training data before data quality enhancement. The average completeness score for these 10 boards is 0.76. Then, the 12 boards are used as training data after data quality improvement by filling in the missing data using mean imputation. Consequently, the data quality metrics before data quality improvement can be represented as Q=[10, 0.76]. In contrast, the six test boards remain unchanged, ensuring the models are tested on the same dataset.

As previously mentioned, the decisions made by the decision tree-based model depend on the knowledge K(Q,Ω, r, [symbol] ) and the minimum performance standard C. To rigorously validate the proposed framework, confusion matrices may be generated to compare the predicted decisions and actual decisions. The predicted decisions are derived from the decision models based on decision tree models. On the other hand, the actual decisions are inferred from the test results on the test data. Specifically, the four trained models are applied to the test data, and the model losses are calculated and compared to the minimum model performance requirement C. If the loss of the four models is greater than C, then actual decision is “Improve DQ”, otherwise, the corresponding model with the smallest loss is the best model.

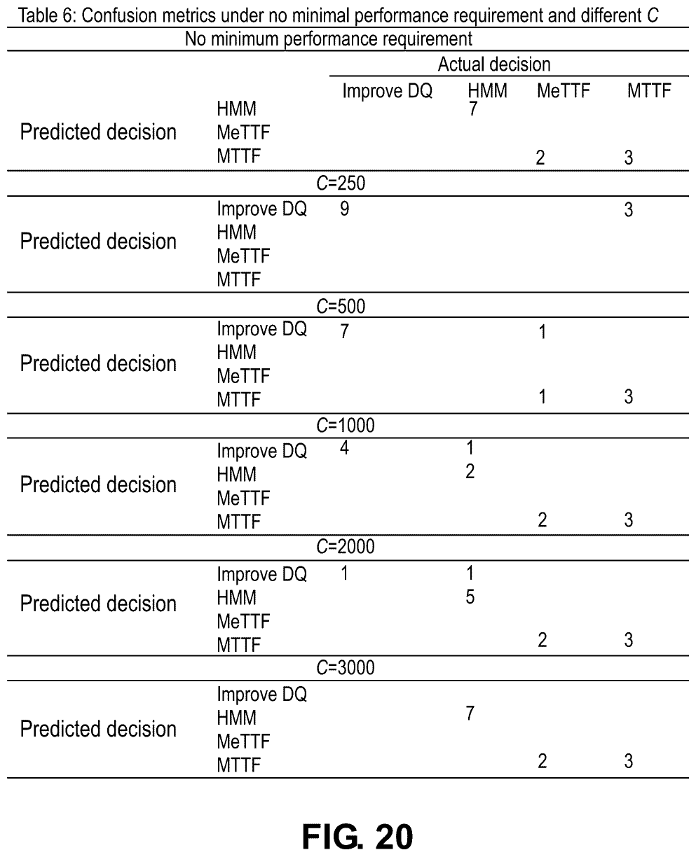

These comparisons are made under varying cost ratios r and C. The cost ratios used in this subsection are the same as defined above in the sequence L3, while the values of C are consistent with the decision models shown in FIGS. 15-19. FIG. 20 illustrates results of the confusion metrics under different, according to an embodiment. From the table, the average decision accuracy can be computed, that is:

$$\frac{10 + 9 + 10 + 9 + 9 + 10}{12 \times 6} x = 100 \% = 79.17 \% , \qquad ( 6 )$$

which proves the effectiveness of the framework.

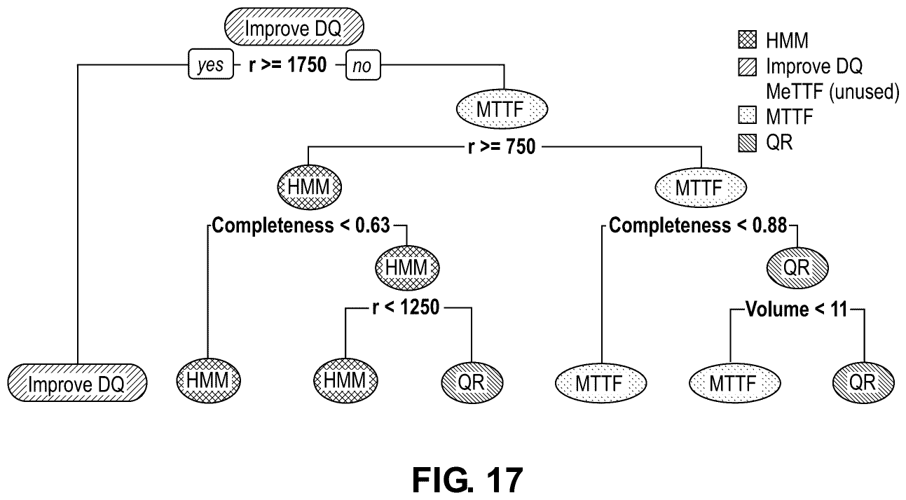

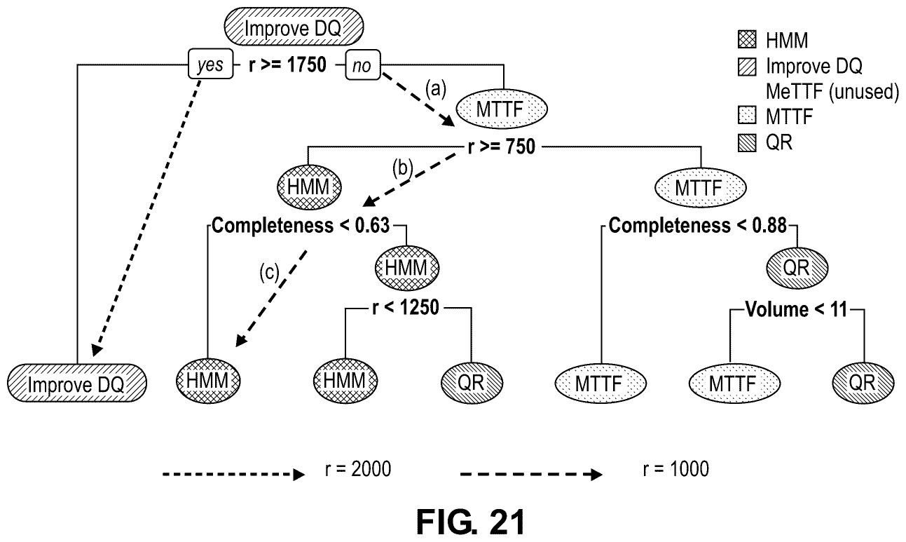

Given the cost ratio and minimum model performance standard, the desire to improve data quality can be determined with the help of the corresponding decision model. As an example, suppose the minimum model performance standard C is fixed at 1000. This example examines two scenarios involving the cost ratio r of the equipment under study. In the first scenario, when the cost ratio r is set at 1000, the decision model depicted in FIG. 17 suggests that the data quality (i.e., Q=[10, 0.76]) is satisfactory, and as a result, the HMM is selected to construct the risk estimation model. In the second scenario, with the cost ratio is r set at 2000, the decision model indicates that the data quality should be enhanced. FIG. 21 illustrates a decision derivation process (e.g., for both scenarios), according to an embodiment.

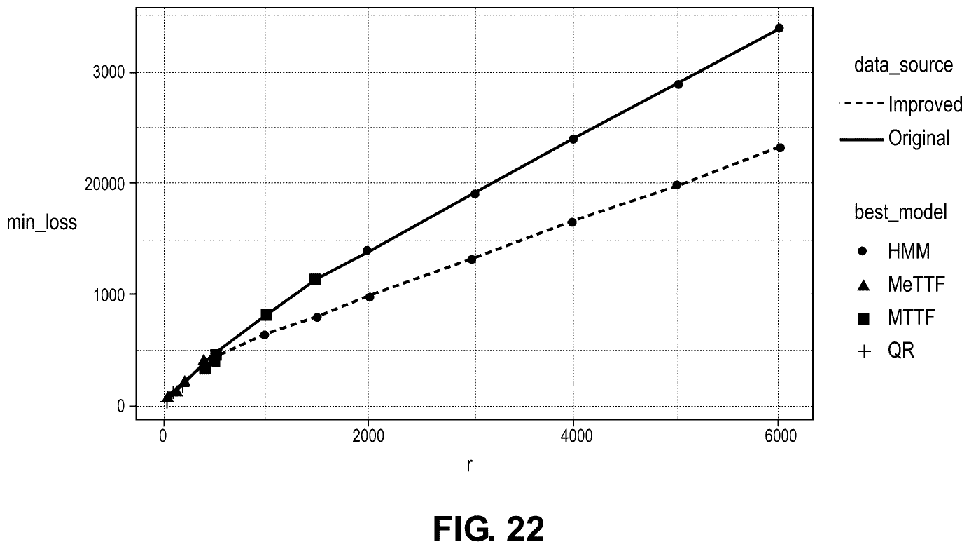

FIG. 22 illustrates the model's performance before and after the data quality improvement, achieved by including two additional failed boards and addressing missing values, according to an embodiment. The data quality after data quality improvement is Q′=[12, 1]. From the figure, it can be seen that the data quality improvement leads to a reduction in losses, especially when the cost ratios are large.

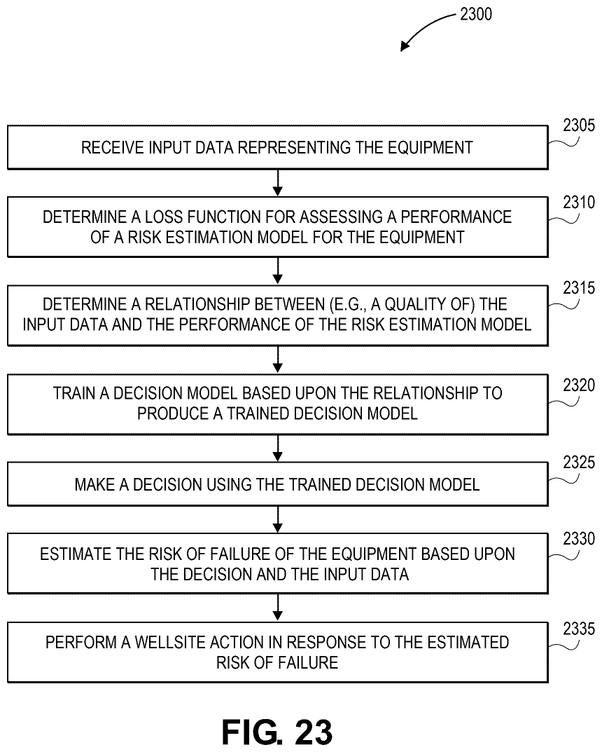

FIG. 23 illustrates a flowchart of a method 2300 for managing a quality of data that is used to estimate a risk of failure of equipment, according to an embodiment. The method 2300 may also or instead be for estimating the risk of failure of the equipment. An illustrative order of the method 2300 is provided below; however, one or more portions of the method 2300 may be performed in a different order, simultaneously, repeated, or omitted. At least a portion of the method 2300 may be performed with a computing system 2400 (described below).

The method 2300 may include receiving input data representing the equipment, as at 2305. The input data may be measured by one or more sensors on the equipment. The one or more sensors may be part of a computerized maintenance management system (CMMS) associated with the equipment. The input data may be or include electrical current data, electrical voltage data, shock data, vibration data, temperature data, or a combination thereof. The equipment may be or include a downhole tool or a surface tool that is configured to be used at a wellsite. For example, the downhole tool may be or include a bottom hole assembly (BHA), a measurement-while-drilling (MWD) tool, a logging-while-drilling (LWD) tool, a rotary steerable system (RSS), a mud motor, a drill bit, or the like.

The method 2300 may also include determining a loss function for assessing a performance of a risk estimation model for the equipment, as at 2310. The risk estimation model may be configured to estimate the risk of failure of the equipment. The loss function may be represented by Equation (3) above, where:
[symbol] represents the loss function.
N represents a number of the equipment (e.g., five drilling tools).
[symbol] represents a time when one of the equipment i is replaced based upon a failure risk estimation (e.g., by the risk estimation model). Each equipment's life starts at time 0. The equipment i is replaced when the failure risk estimation reaches a predetermined level.
[symbol] represents an actual life of the equipment i based upon a time when the equipment i actually fails.
r represents a cost ratio comprising a unit failure cost of the equipment i divided by a premature replacement cost of the equipment i per unit time. The unit failure cost is a cost caused by an undetected failure of the equipment i.
I represents an indicator function. In an example, the indicator function may be defined as I(x)=1 if the condition x is true; otherwise=0.

In one embodiment, [symbol] ≥ [symbol] means that the equipment i is replaced after equipment i fails, which incurs a failure cost. In another embodiment, [symbol] < [symbol] means that the equipment i is replaced more than a predetermined amount of time (e.g., 1 month) before the equipment i would fail, which incurs a premature replacement cost.

The method 2300 may also include determining a relationship between (e.g., a quality of) the input data and the performance of the risk estimation model, as at 2315. The relationship may be determined based at least partially upon the loss function. The relationship may also or instead be (e.g. indirectly) determined based upon data from similar equipment that is similar to the equipment. In an example, the relationship may be determined by removing or modifying segments of the data from the similar equipment to produce synthetic datasets having different levels of data quality. The relationship may be represented by: K(Q,Ω, r, [symbol] ), where:
K represents a function notation such as f(x);
Q represents a vector containing data quality metrics such as [n, comp]=[12, 0.8], wherein n is the data volume, and comp is the completeness;
Ω represents risk estimation models;
r represents the cost ratio; and
[symbol] represents the loss function.

The method 2300 may also include training a decision model based upon the relationship to produce a trained decision model, as at 2320. More particularly, the decision model may be trained based upon the synthetic datasets. The decision model may also or instead be trained using (or based upon) a decision tree algorithm.

The method 2300 may also include making a decision using the trained decision model, as at 2325. The trained decision model may be expressed as:

D=g(C,K(Q,Ω, r, [symbol] )) (i.e., Equation 4)
where:
D represents the decision that indicates that the input data meets predetermined data quality requirements. The decision may also or instead select the risk estimation model, out of a plurality of risk estimation models, to use to estimate the risk of failure of the equipment.
g represents a mean function; and
C represents a minimum performance requirement such as 500, 1000, 2000.

The method 2300 may also include estimating the risk of failure of the equipment based upon the decision, as at 2330. More particularly, the risk of failure may be estimated using the selected risk estimation model. The risk of failure may be based upon the input data.

The method 2300 may also include performing a wellsite action in response to the estimated risk of failure, as at 2335. For example, the wellsite action may be performed in response to the estimated risk being greater than a predetermined threshold (e.g., 70%). The wellsite action may be or include generating and/or transmitting a signal (e.g., using a computing system) that instructs or causes a physical action to occur at a wellsite. The wellsite action may also or instead include performing the physical action at the wellsite. The physical action may be or include repairing or replacing the equipment. The physical action may also or instead include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

### Exemplary Computing System

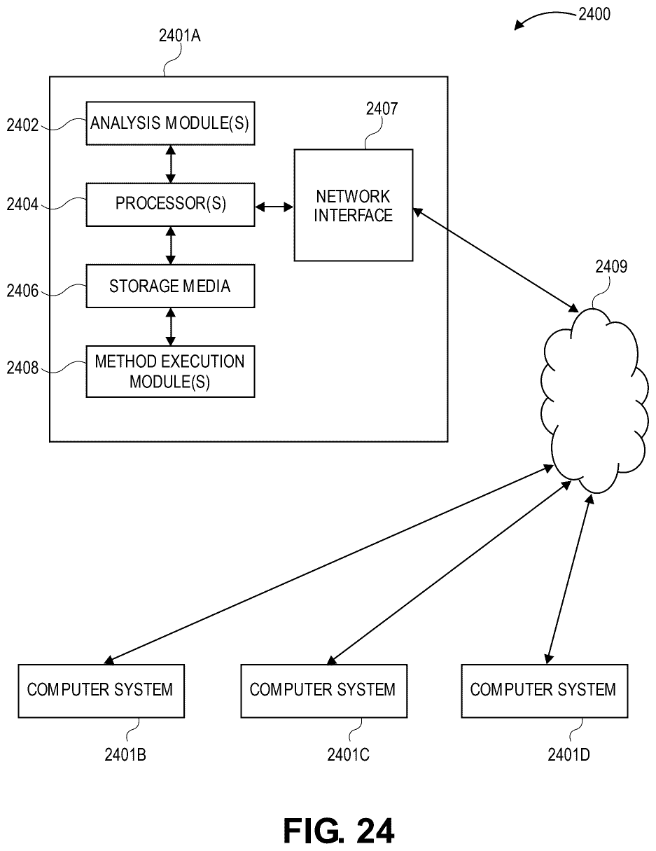

In some embodiments, the methods of the present disclosure may be executed by a computing system. FIG. 24 illustrates an example of such a computing system 2400, in accordance with some embodiments. The computing system 2400 may include a computer or computer system 2401A, which may be an individual computer system 2401A or an arrangement of distributed computer systems. The computer system 2401A includes one or more analysis modules 2402 that are configured to perform various tasks according to some embodiments, such as one or more methods disclosed herein. To perform these various tasks, the analysis module 2402 executes independently, or in coordination with, one or more processors 2404, which is (or are) connected to one or more storage media 2406. The processor(s) 2404 is (or are) also connected to a network interface 2407 to allow the computer system 2401A to communicate over a data network 2409 with one or more additional computer systems and/or computing systems, such as 2401B, 2401C, and/or 2401D (note that computer systems 2401B, 2401C and/or 2401D may or may not share the same architecture as computer system 2401A, and may be located in different physical locations, e.g., computer systems 2401A and 2401B may be located in a processing facility, while in communication with one or more computer systems such as 2401C and/or 2401D that are located in one or more data centers, and/or located in varying countries on different continents).

A processor may include a microprocessor, microcontroller, processor module or subsystem, programmable integrated circuit, programmable gate array, or another control or computing device.

The storage media 2406 may be implemented as one or more computer-readable or machine-readable storage media. Note that while in the example embodiment of FIG. 24 storage media 2406 is depicted as within computer system 2401A, in some embodiments, storage media 2406 may be distributed within and/or across multiple internal and/or external enclosures of computing system 2401A and/or additional computing systems. Storage media 2406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 2400 contains one or more method execution module(s) 2408. In the example of computing system 2400, computer system 2401A includes the method execution module 2408. In some embodiments, a single method execution module may be used to perform some aspects of one or more embodiments of the methods disclosed herein. In other embodiments, a plurality of method execution modules may be used to perform some aspects of methods herein.

It should be appreciated that computing system 2400 is merely one example of a computing system, and that computing system 2400 may have more or fewer components than shown, may combine additional components not depicted in the example embodiment of FIG. 24, and/or computing system 2400 may have a different configuration or arrangement of the components depicted in FIG. 24. The various components shown in FIG. 24 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 2400, FIG. 24), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for managing a quality of data that is used to estimate a risk of failure of equipment, the method comprising:
receiving input data representing the equipment;
determining a loss function for assessing a performance of a risk estimation model for the equipment;
determining a relationship between the input data and the performance of the risk estimation model, wherein the relationship is determined based upon the loss function;
training a decision model based upon the relationship to produce a trained decision model;
making a decision using the trained decision model; and
estimating the risk of failure of the equipment based upon the decision and the input data.

2. The method of claim 1, wherein the input data is measured by one or more sensors on the equipment.

3. The method of claim 2, wherein the one or more sensors are part of a computerized maintenance management system (CMMS) associated with the equipment.

4. The method of claim 1, wherein the input data comprises electrical current data, electrical voltage data, shock data, vibration data, temperature data, or a combination thereof.

5. The method of claim 1, wherein the equipment comprises a downhole tool or a surface tool that is configured to be used at a wellsite.

6. The method of claim 1, wherein the relationship is between a quality of the input data and the performance of the risk estimation model.

7. The method of claim 1, wherein the relationship is also determined based upon data from similar equipment that is similar to the equipment.

8. The method of claim 7, wherein the relationship is determined by removing or modifying segments of the data from the similar equipment to produce synthetic datasets comprising different levels of data quality, and wherein the decision model is trained based upon the synthetic datasets.

9. The method of claim 1, wherein the decision indicates that the input data meets predetermined data quality requirements, and wherein the decision also selects the risk estimation model, out of a plurality of risk estimation models, to use to estimate the risk of failure of the equipment.

10. The method of claim 1, further comprising repairing or replacing the equipment in response to the estimated risk of failure exceeding a predetermined threshold.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data representing the equipment, wherein the input data is measured by one or more sensors on the equipment, wherein the equipment comprises a downhole tool or a surface tool that is configured to be used at a wellsite;
determining a loss function for assessing a performance of a risk estimation model for the equipment, wherein the risk estimation model is configured to estimate the risk of failure of the equipment;
determining a relationship between a quality of the input data and the performance of the risk estimation model, wherein the relationship is determined based upon the loss function, wherein the relationship is also determined based upon data from similar equipment that is similar to the equipment, and wherein the relationship is determined by removing or modifying segments of the data from the similar equipment to produce synthetic datasets comprising different levels of data quality;
training a decision model based upon the relationship and a decision tree algorithm to produce a trained decision model, wherein the decision model is trained based upon the synthetic datasets;
making a decision using the trained decision model; and
estimating the risk of failure of the equipment based upon the decision and the input data.

12. The computing system of claim 11, wherein the loss function is based upon:
a number of the equipment;
a time when a first of the equipment is replaced based upon a failure risk estimation, wherein the first equipment is replaced when the failure risk estimation reaches a predetermined level;
an actual life of the first equipment based upon a time when the first equipment actually fails;
a cost ratio comprising a unit failure cost of the first equipment divided by a premature replacement cost of the first equipment per unit time, wherein the unit failure cost comprises a cost caused by an undetected failure of the first equipment; and
an indicator function.

13. The computing system of claim 11, wherein the relationship is based upon:
a vector containing data quality metrics;
a plurality of risk estimation models including the risk estimation model;
a cost ratio; and
the loss function.

14. The computing system of claim 11, wherein the decision indicates that the input data meets predetermined data quality requirements, and wherein the decision also selects the risk estimation model, out of the plurality of risk estimation models, to use to estimate the risk of failure of the equipment.

15. The computing system of claim 11, wherein the operations further comprise performing a wellsite action in response to the estimated risk of failure exceeding a predetermined threshold.

16. A non-transitory computer-readable medium storing instructions that, when executed by one or more processors of a computing system, cause the computing system to perform operations, the operations comprising:
receiving input data representing the equipment, wherein the input data is measured by one or more sensors on the equipment, wherein the one or more sensors are part of a computerized maintenance management system (CMMS) associated with the equipment, wherein the input data comprises electrical current data, electrical voltage data, shock data, vibration data, temperature data, or a combination thereof, and wherein the equipment comprises a downhole tool or a surface tool that is configured to be used at a wellsite;
determining a loss function for assessing a performance of a risk estimation model for the equipment, wherein the risk estimation model is configured to estimate the risk of failure of the equipment, and wherein the loss function comprises:
$$ℓ ∝ r \times \frac{{\sum }_{i = 1}^{N} ( {\hat{T}}_{i} \geq {T}_{i} )}{{\underbrace{N}}_{term 1}} + \frac{{\sum }_{i = 1}^{N} ( {T}_{i} - {\hat{T}}_{i} ) ( {\hat{T}}_{i} < {T}_{i} )}{{\underbrace{N}}_{term 2}} .$$
where: [symbol]
represents the loss function;
N represents a number of equipment;
\hat{ }Ti represents a time when one of the equipment i is replaced based upon a failure risk estimation, wherein each equipment's life starts at time 0, and wherein the equipment i is replaced when the failure risk estimation reaches a predetermined level;
Ti represents an actual life of the equipment i based upon a time when the equipment i actually fails;
r represents a cost ratio comprising a unit failure cost of the equipment i divided by a premature replacement cost of the component i per unit time, wherein the unit failure cost comprises a cost caused by an undetected failure of the equipment i; and
I represents an indicator function;
determining a relationship between a quality of the input data and the performance of the risk estimation model, wherein the relationship is determined based upon the loss function, wherein the relationship is also determined based upon data from similar equipment that is similar to the equipment, wherein the relationship is determined by removing or modifying segments of the data from the similar equipment to produce synthetic datasets comprising different levels of data quality;
training a decision model based upon the relationship and a decision tree algorithm to produce a trained decision model, wherein the decision model is trained based upon the synthetic datasets;
making a decision using the trained decision model; and
estimating the risk of failure of the equipment based upon the decision, wherein the risk of failure is estimated using the selected risk estimation model, and wherein the risk of failure is also based upon the input data.

17. The non-transitory computer-readable medium of claim 16, wherein [symbol] ≥ [symbol] means that the equipment i is replaced after equipment i fails, which incurs a failure cost, and wherein [symbol] < [symbol] means that the equipment i is replaced more than a predetermined amount of time before the equipment i would fail, which incurs a premature replacement cost.

18. The non-transitory computer-readable medium of claim 16, wherein the relationship is represented as:
K(Q,Ω, r, [symbol] )
where:
K represents a function to characterize the relationship;
Q represents a vector containing data quality metrics;
Ω represents a plurality of risk estimation models including the risk estimation model;
r represents the cost ratio; and [symbol]
represents the loss function.

19. The non-transitory computer-readable medium of claim 16, wherein the trained decision model is represented as:
$$D = g ( C , K ( Q , Ω , r , ℓ ) )$$
where:
D represents the decision that indicates that the input data meets predetermined data quality requirements, wherein the decision also selects the risk estimation model, out of the plurality of risk estimation models, to use to estimate the risk of failure of the equipment;
g represents a function; and
C represents a minimum performance requirement.

20. The non-transitory computer-readable medium of claim 16, wherein the operations further comprise performing a wellsite action in response to the estimated risk of failure exceeding a predetermined threshold, wherein performing the wellsite action comprises generating and/or transmitting a signal that instructs or causes a physical action to occur at the wellsite, and wherein the physical action comprises repairing or replacing the equipment.
